(19) United States
(12) Patent Application Publication
(10) Pub. No.: US 2003/0048280 A1
(43) Pub. Date: Mar. 13, 2003

(54) Interactive environment using computer vision and touchscreens

(76) Inventor: Ryan S. Russell, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/952,085

(22) Filed: Sep. 12, 2001

(51) Int. Cl. G09G 5/00

(52) U.S. Cl. 345/619

(57) ABSTRACT

An interactive environment is created through the use of a touchscreen and a camera. A user can select an object on a display by touching the object on a touchscreen. A computer can activate a video camera in response to the touch. The video camera then inputs images of the user's physical movements to the computer, and the computer uses software to analyze the user's movements and apply corresponding manipulations to the object. For example, the user may select an object by touching a touchscreen near the object on a display and then rotate his or her hand to rotate the displayed object on the display.

### BACKGROUND OF THE INVENTION

1. Field of the Invention

The present invention relates to computers. In particular, the present invention relates to the combination of a video camera and a touchscreen to create an interactive environment for computer users.

2. Background of the Related Art

Interactive computer environments may be used for several types of applications including games, online shopping, and office applications. Interactive computer environments may allow users to use alternate types of input devices other than the standard keyboard and mouse. Many of these alternate input devices require a large amount of computing power, and conventional computer systems are generally restricted to one alternate type of input device in addition to the conventional keyboard and computer mouse.

Alternate input devices may allow computers to receive user input in various forms. For example, point-of-sale computers or automated teller machines may use touchscreens to allow users to select an object on a screen or push an on-screen button by touching the screen, and provide screen coordinates identifying where the touchscreen was touched. Further data input may be handled through additional touches on the touchscreen, or through a keyboard. In other types of systems, video cameras may be used to input a user's movements into a computer. The computer may then use gesture recognition software to interpret and apply the user's movements to the application environment. The number of gestures than may be recognized in this manner is limited, so the remaining inputs may be handled through a standard keyboard and/or mouse.

In both cases, switching between touchscreen or video camera and keyboard/mouse input can be awkward and inefficient.

### BRIEF DESCRIPTION OF THE DRAWINGS

The present invention is illustrated by way of example and not limitation in the accompanying figures:

FIG. 1 shows an embodiment of the invention with a video camera and touchscreen.

FIG. 2 shows an embodiment of the invention with a seated user.

FIG. 3 shows an embodiment of the invention with a standing user.

FIG. 4 shows a user selecting an object on a touchscreen, according to one embodiment of the invention.

FIG. 5 shows a user manipulating an object by moving a body part, according to one embodiment of the invention.

FIG. 6 shows a flowchart of a user's actions, according to one embodiment of the invention.

FIG. 7 shows a flowchart of system operations, according to one embodiment of the invention.

FIG. 8 shows a flowchart of system operations contained on a machine readable medium, according to one embodiment of the invention.

### DETAILED DESCRIPTION OF THE INVENTION

The following description makes reference to numerous specific details in order to provide a thorough understanding of the present invention. However, it is to be noted that not every specific detail need be employed to practice the present invention. Additionally, well-known details, such as particular materials or methods, have not been described in order to avoid obscuring the invention.

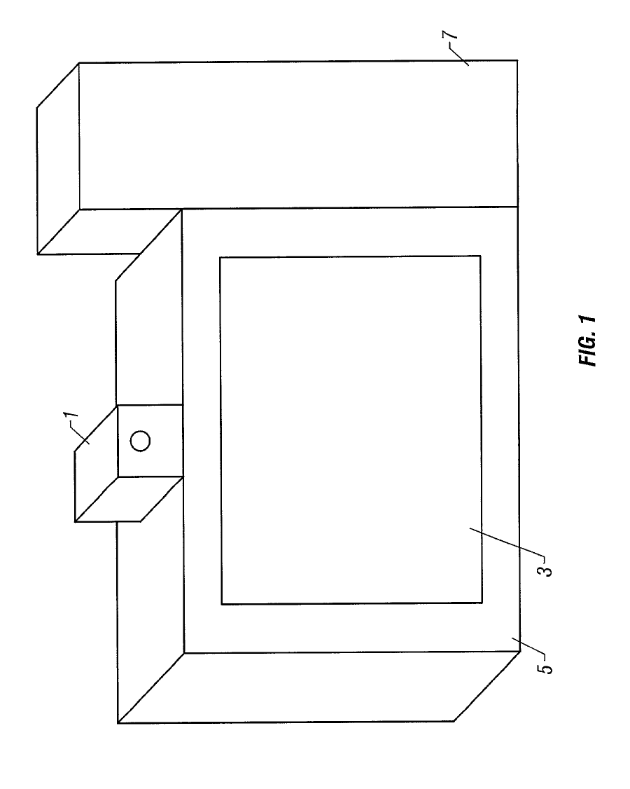

FIG. 1 shows an embodiment of the invention with a video camera and touchscreen. FIG. 1 shows a video camera 1, a touchscreen 3, a display 5 (such as a monitor), and a computer 7 having a memory. In the embodiment of FIG. 1, video camera 1 is coupled to computer 7, computer 7 is coupled to display 5, and an interactive environment is displayed on display 5. Touchscreen 3 is coupled to display 5 and/or computer 7. The user may touch touchscreen 3 at a point where an object is in the interactive environment shown on display 5. In one embodiment, computer 7 then activates video camera 1. In another embodiment, video camera 1 stays on continuously, and the software to interpret the user's movements is activated in response to the touch. In still another embodiment, video camera 1 stays on continuously and the software is activated continuously. Video camera 1 is used to input a user's movements after the user has selected an object by touching the object on touchscreen 3. In various embodiments, video camera 1 is a visible light camera or an infrared camera. In various embodiments, video camera 1 is a digital or analog camera. Other types of cameras 1 are also within the scope of the invention. Video camera 1 may be located above display 5, inside of display 5 looking out, or anywhere else it can view a user. The video frames from video camera 1 may be interpreted by computer 7 using software such as, but not limited to, gesture recognition software, tracking software, and video segmentation software. The user should know what motions, such as but not limited to gestures, can be recognized by the software so that the user can perform those motions as needed. Computer 7 then manipulates the selected object in the environment shown by display 5 according to the user's movements.

In various embodiments, touchscreen 3 may be a resistive touchscreen, a surface acoustic touchscreen, or a capacitive touchscreen. Other touchscreens 3 are also within the scope of the invention. Resistive touchscreens use changes in current to detect a user's touch. A resistive touchscreen may have several layers including, but not limited to, a scratch resistant coating, a conductive layer, separators, a resistive layer, and a glass panel layer. At the site of a touch, the layers compress in response to the touch and correspondingly alter the current running through them. In one embodiment, a touchscreen controller interprets where the touch occurred based on this change in current, and the touchscreen controller then sends this data to a computer 7. In another embodiment, computer 7 performs the function of interpreting where the touch occurred from the change in current. In various embodiments, a software driver installed on computer 7 allows computer 7 to interpret the data to identify which object displayed on display 5 has been touched. Resistive touchscreens may work with the user's finger and/or with other pointing devices.

Touchscreen 3 may also be a surface acoustic wave touchscreen. On an acoustic wave touchscreen, sound is sent and received by transducers. A transducer sends a preset level of sound across the touchscreen surface (such as a clear glass panel) and/or receives sound from the touchscreen surface. The sound received by a transducer may be sound that has been sent by other transducers, sound that has been bounced back to the transducer from reflectors, a combination of both, or other variations not specifically described here. When a user touches the clear glass panel, the user's finger or object used to touch the clear glass panel absorbs some of the sound traveling across it. In one embodiment, the touchscreen controller uses the changing levels of sound received by the transducers on touchscreen 3 to detect where touchscreen 3 was touched, and then sends this data to computer 7. In another embodiment, computer 7 performs the function of using the changing levels of sound received by the transducers to detect where touchscreen 3 was touched. In various embodiments, an installed software driver in the computer 7 may be used to identify which object displayed on display 5 has been touched. Surface acoustic wave touchscreens may work with the user's finger, a soft tipped stylus, or any object that will absorb a sufficient amount of sound to be detected.

Touchscreen 3 may be a capacitive touchscreen. Capacitive touchscreens use a glass panel coated with a capacitive material. Circuits in the corners or at the edges of touchscreen 3 use current to measure capacitance across touchscreen 3. If a user touches touchscreen 3, the user's finger draws current proportionately from each side of touchscreen 3. In one embodiment, a touchscreen controller uses the frequency changes resulting from the proportionate current change to calculate the coordinates of the user's touch. This data may then be passed to computer 7. In another embodiment, computer 7 may perform the function of using frequency changes resulting from the proportionate current change to calculate the coordinates of the user's touch. In various embodiments, an installed software driver in computer 7 is used to identify which object displayed on display 5 has been touched. Other objects besides the user's finger may not work on a capacitive touchscreen because the proportionate current draw may be based on the electro-capacitive characteristics of a human finger.

Touchscreen 3 may be coupled to the outside of a display 5, may be built into display 5, and may be disposed in other locations as well. Touchscreen 3 may be coupled to computer 7 through a serial port connection, a personal computer (PC) bus card, or any other suitable signal interface. Touchscreen 3 may be used with different types of displays 5 including, but not limited to, cathode ray tube (CRT) monitors and liquid crystal display (LCD) monitors. In one embodiment, touchscreen 3 is used on a laptop computer.

In various embodiments, video camera 1 is a digital video camera using charge coupled device (CCD) or complimentary metal oxide semiconductor (CMOS) sensors for light sensors, and/or may use diodes to convert incoming light into electrons. Cells of the CCD or CMOS are used to collect a buildup in charge based on the amount of received light at the sensor. The accumulated charge in each cell is read and an analog-to-digital converter converts the accumulated charge amount into a digital value. The digital values are then used by computer 7 to construct an image of what is in front of video camera 1. The image may be black and white, color, or other image depending on the type of video camera 1. The changes in subsequent images gathered by camera 1 are used to detect user movement and/or gestures in front of video camera 1. Software is then used to interpret these movements as recognizable user motions that can be converted into operations to manipulate an object displayed on display 5.

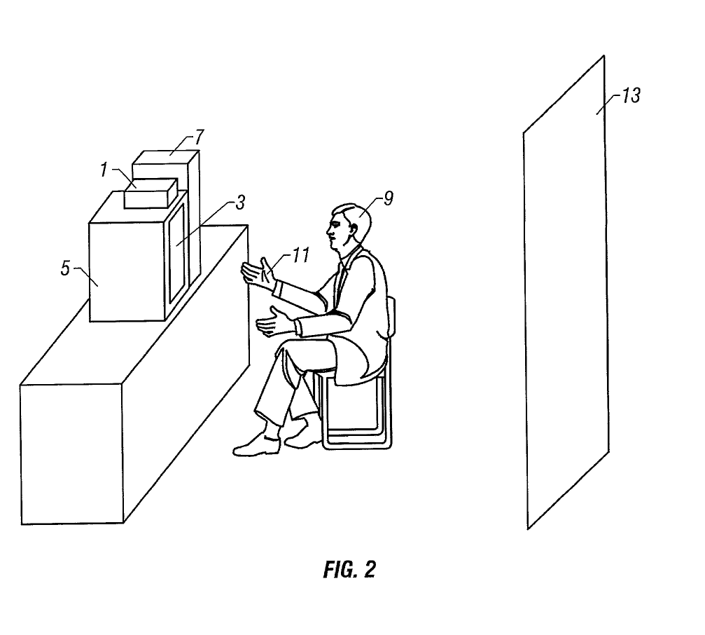

FIG. 2 shows an embodiment of the invention with a seated user 9. In the illustrated embodiment, user 9 is seated between a static (i.e., non-moving) background 13 and a video camera 1. In this configuration, video camera 1 can read the user's movements from body parts above the waist including, but not limited to, the head, arms, hand 11, and fingers. While one video camera 1 is shown, more cameras may be used to read more user's movements or user's movements from other body parts. In addition, more cameras may allow computer 7 to get better resolution of the user's movements to interpret more intricate user movements. In various embodiments, the background is static to eliminate or minimize non-user movement that might inadvertently occur behind or near the user 9, and might be incorrectly interpreted as user movement. Static background 13 may include, but is not limited to, a wall or a screen. If video camera 1 is only observing the user's hand 11, the user's upper body clothing may be used as a static background.

In the illustrated embodiment of FIG. 2, user 9 is seated between a video camera 1 and a static background 13. User 9 is facing a display 5 displaying an application environment (e.g. a computer game). To interact with an object in the application environment, user 9 touches touchscreen 3 at the point of the object. Upon detecting a touch on touchscreen 3, computer 7 activates video camera 1 if the camera is not already activated. Video data from camera 1 is then input into computer 7, which uses software to analyze video frames of the user's movements, determine what command was intended by the user, and apply the associated manipulation assigned to that command to the object selected by user 9. A wide range of user's movements and corresponding object manipulations can be included. For example, user 9 may rotate his hand 11 to rotate the object, move his hand 11 to translate the object, open and close his hand 11 to throw the object, and flap his arms to make the object fly. In one embodiment, user 9 may also be asked questions by computer 7 on how to manipulate the selected object. User 9 may respond by shaking his head from side to side to indicate no and shaking his head up and down to indicate yes. For example, after selecting an object using touchscreen 3, user 9 may shake his head up and down to respond yes to a computer question asking him if he would like to delete the selected object. Other user's movements to manipulate an object are also within the scope of the invention. In addition, while this embodiment shows one display 5 and one touchscreen 3, other embodiments have multiple displays 5 and/or touchscreens 3.

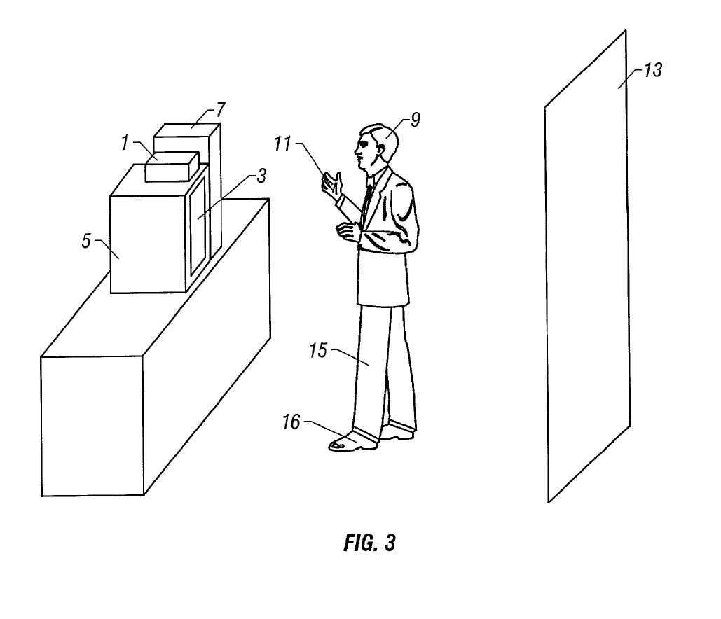

FIG. 3 shows an embodiment of the invention with a standing user 9. In one embodiment, video camera 1 is not limited to reading only actions of the upper body of user 9, but it may input a user's movements from any part of the user's body including, but not limited to, hips, legs 15, knees, and feet 16. For example, video camera 1 may input a user's movements of legs 15 and feet 16 against static background 13. For example, user 9 may kick his leg 15 to kick an object or rotate his foot 16 to increase the size of an object. A computer 7 may use software to interpret video frames of the user's movements from a video camera 1 and manipulate the selected object on display 5. In the illustrated embodiment, video camera 1 may view the entire user 9, or just a portion such as the upper or lower half of a standing user 9. In various embodiments, video camera 1 may be mounted to the top of display 5, mounted separately from display 5, or mounted anywhere it provides a suitable view of user 9. In one embodiment, multiple cameras 1 may be used to increase the resolution of the user's movements, to view different parts of the user's body, or for other reasons. Static background 13 may be a static object including, but not limited to, a back wall or a screen behind user 9. In one embodiment, multiple displays 5 and touchscreens 3 are used. Display 5 and touchscreen 3 may also be larger or smaller than the display 5 and touchscreen 3 shown, depending on the application.

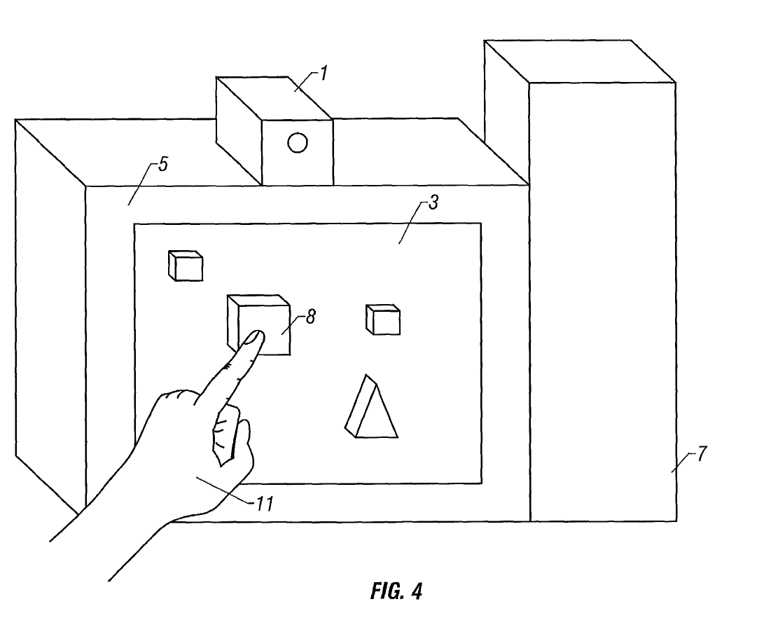

FIG. 4 shows a user selecting an object on a touchscreen, according to one embodiment of the invention. The touchscreen of this embodiment is located directly over the display. The user selects an object on display 5 by attempting to touch the object on the display, which causes the user's finger to touch an area of touchscreen 3 that is directly over the displayed object. Touchscreen 3 may be located over display 5 so that each area of touchscreen 3 corresponds to a known area of display 5. Computer 7 converts the touchscreen coordinates to coordinates for the display, and searches the displayed image for an object near the coordinates of the display. In one embodiment, the displayed object also has display coordinates and the search includes a comparison of object coordinates with coordinates of the touched area. In one embodiment, the computer 7 considers an object within a predetermined distance of the touch to be near the touch. If an object is at or near the touched area, such as selected object 8, computer 7 analyzes video frames of the user's movements from camera 1, interprets those movements to derive an associated operation, and applies that operation to selected object 8.

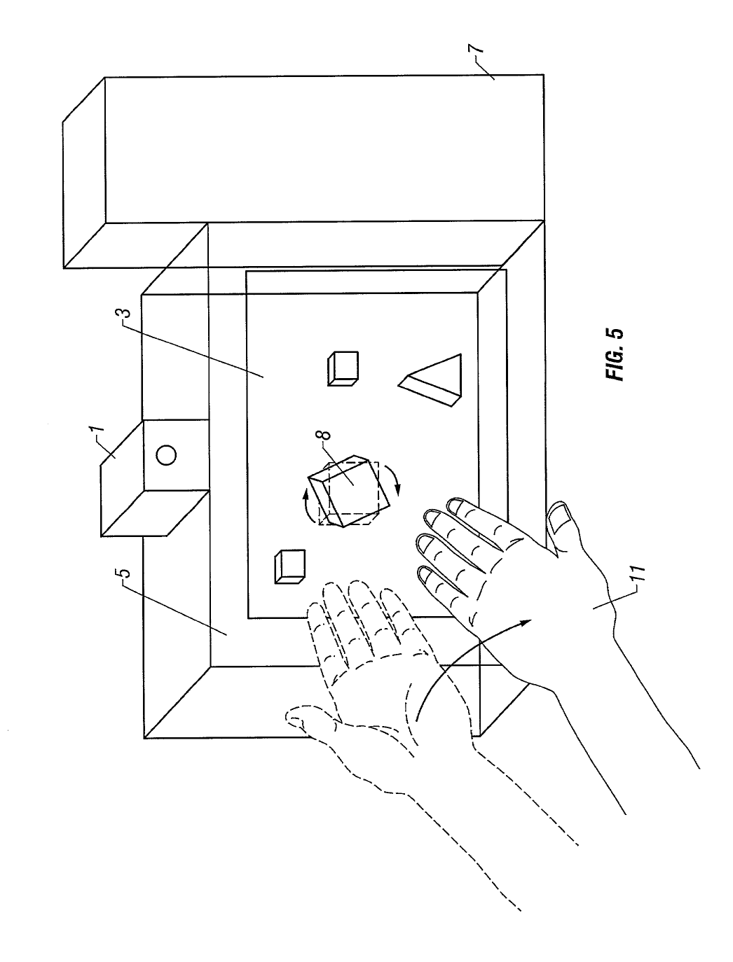

FIG. 5 shows a user manipulating an object by moving a body part, according to one embodiment of the invention. If the user rotates his hand 11 in view of camera 1, computer 7 may analyze the video frames of rotating hand 11 using software such as, but not limited to, gesture recognition software, tracking software, and video segmentation software. Computer 7 may then rotate the image of selected object 8, or manipulate selected object 8 in other ways according to the preset operation associated with a rotating hand 11.

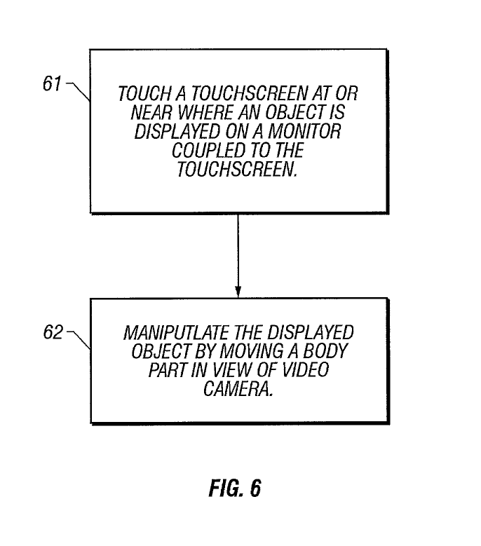

FIG. 6 shows a flowchart of a user's actions, according to one embodiment of the invention. At block 61 the user touches a touchscreen at or near where an object is displayed on a display coupled to the touchscreen. In one embodiment, the display is a monitor. At block 62, the user manipulates the displayed object by moving a body part in view of a camera.

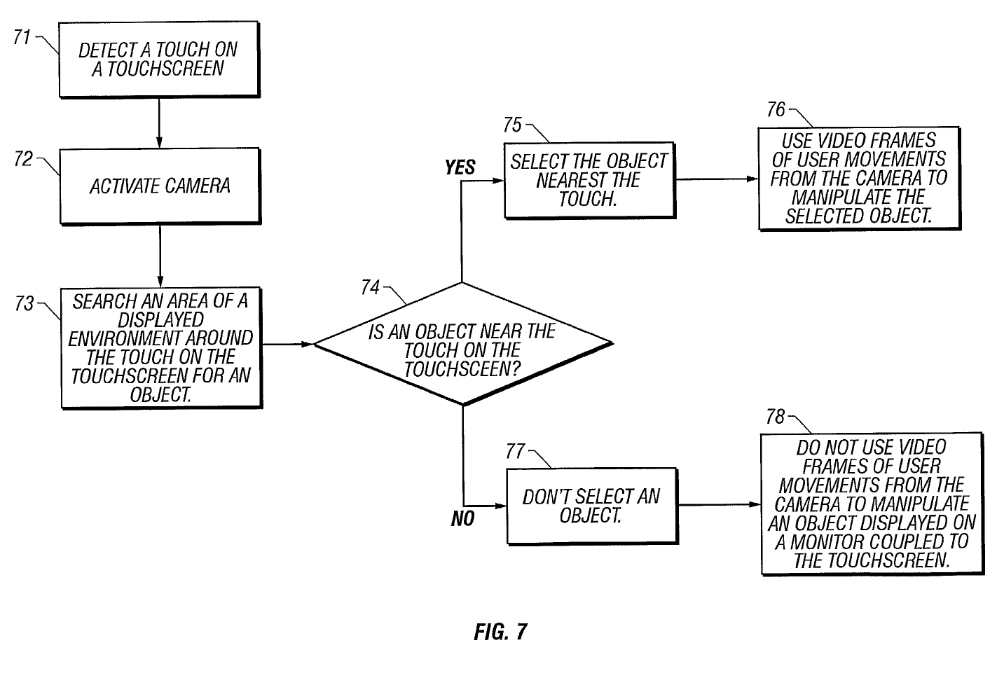

FIG. 7 shows a flowchart of system operations, according to one embodiment of the invention. At block 71, the system detects a touch on a touchscreen. At block 72 the system activates a video camera in response to detecting a touch. At block 73, the system searches an area of a displayed environment around the touched area for an object. At decision block 74, the system determines whether an object is near the touch on the touchscreen, i.e., whether the object is within a predetermined distance of the touch. If an object is near the touch, then at block 75, the object near the touch is selected. In one embodiment, if there is more than one object near the touch, the object nearest to the touch is selected. If an object has been selected, then at block 76, the system uses the video frames of the user's movements from the video camera to manipulate the selected object. If there is no object near the touch on the touchscreen, then at block 77, no object is selected. If no object has been selected, then at block 78, the system ignores user input as provided through video frames. In one embodiment, if no object is selected then no video frames are input and block 78 may be ignored.

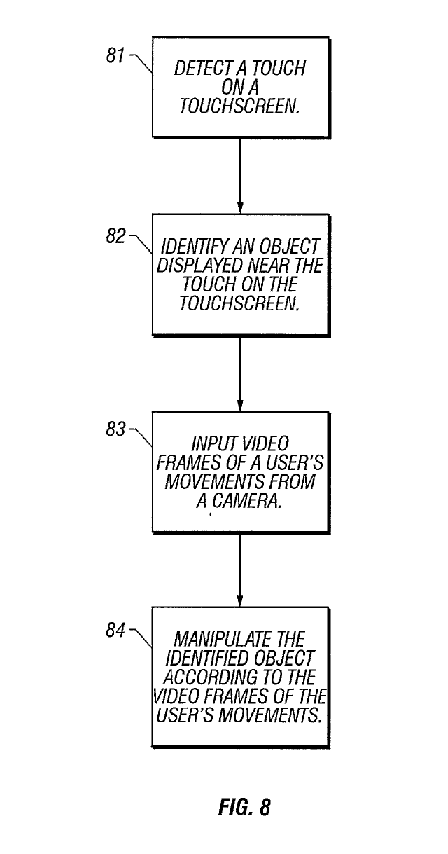

FIG. 8 shows a flowchart of system operations contained on a machine readable medium, according to one embodiment of the invention. A machine-readable medium may include any mechanism that provides (i.e. stores and/or transmits) information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g. carrier waves, infrared signals, digital signals, etc.); etc. By way of example and not limitation, at block 81 the system detects a touch on a touchscreen. At block 82, the system identifies an object near the touch on the touchscreen. If there is more than one object displayed near the touch, the object displayed nearest to the touch may be selected. At block 83, the system uses a video camera to input video frames of a user's movements. At block 84, the system manipulates the identified object according to the video frames of the user's movements. The system may use software such as, but not limited to, gesture recognition software, tracking software, and video segmentation software to interpret the video frames of the user's movements for manipulating the identified object. For example, the identified object may be rotated or translated according to the user's movements.

Although an exemplary embodiment of the invention has been shown and described in the form of a camera, touchscreen, and computer, many changes, modifications, and substitutions may be made without departing from the spirit and scope of this invention.

We claim:

1. An apparatus comprising:
a video camera;
a touchscreen; and
a computer coupled to the video camera and the touchscreen to manipulate an object selected with the touchscreen, based on user movements viewed by the video camera.

2. The apparatus of claim 1 further comprising a display coupled to the computer to display the object.

3. The apparatus of claim 2 wherein the touchscreen is coupled to the display.

4. The apparatus of claim 1 wherein said video camera is to be activated by a user touching the touchscreen.

5. A method comprising:
detecting a touch on a touchscreen; and
in response to said detecting, inputting viewed user movement from a video camera.

6. The method of claim 5 further comprising searching an area of a displayed environment for an object near the touch.

7. The method of claim 6 further comprising determining if a displayed object is selected, including:
if an object is near an area of the touch, selecting the object; and
if no object is near the area of the touch, not selecting any object.

8. The method of claim 6, wherein searching includes: if multiple objects are displayed near the touch, selecting a particular one of said multiple objects nearest to the touch.

9. The method of claim 7 further comprising:
if the object has been selected, using interpretation of the viewed user movement to manipulate the selected object.

10. The method of claim 5 wherein the viewed user movement includes viewed movement of a user's body part in a group comprising an arm, hand, finger, head, hip, leg, knee, and foot.

11. The method of claim 10 wherein the viewed user movement occurs between a static background and the camera.

12. The method of claim 10 wherein the viewed user movement represents a software recognizable motion.

13. The method of claim 5, wherein inputting viewed user movement includes using software selected from a group comprising gesture recognition software, tracking software, and video segmentation software on video frames of said user movements to determine how a selected object should be manipulated.

14. A system comprising:
a computer having a memory;
a video camera coupled to said computer;
a display coupled to said computer;
a touchscreen coupled to said computer; and
software for execution by said computer to manipulate an object displayed on the display in response to selecting the object with the touchscreen and performing
a motion by a user in view of the video camera.

15. The system of claim 14 wherein the software is selected from a group comprising gesture recognition software, tracking software, and video segmentation software.

16. The system of claim 14 wherein the video camera is located above said display.

17. The system of claim 14 wherein the video camera includes a visible light camera.

18. The system of claim 14 further comprising a static background in a view of the video camera.

19. A machine-readable medium that provides instructions, which when executed by a machine, cause said machine to perform operations comprising:
detecting a touch on a touchscreen;
identifying an object displayed near said touch on said touchscreen;
using a video camera to input video frames of a user's movements; and
manipulating said identified object according to said video frames of said user's movements.

20. The machine-readable medium of claim 19 wherein manipulating the identified object includes executing software selected from a group comprising gesture recognition software, tracking software, and video segmentation software.

21. The machine-readable medium of claim 19 wherein the identified object is manipulated by a user movement selected from a group comprising rotating and translating.
